(19) United States
(12) Patent Application Publication
(10) Pub. No.: US 2002/0014580 A1
(43) Pub. Date: Feb. 7, 2002

(54) Optoelectronic oscilloscope probe for measuring floating electrical signals

(76) Inventor: Mathias Schumann, Chemnitz (DE)

Correspondence Address: COLLARD & ROE, P.C., 1077 Northern Boulevard, Roslyn, NY, 11576-1696, US

(21) Appl. No.: 09/884,716

(22) Filed: Jun. 19, 2001

(30) Foreign Application Priority Data
Jun. 20, 2000 (DE) 200 10 959.6

(51) Int. Cl. G01J 5/08

(52) U.S. Cl. 250/227.11

(57) ABSTRACT

An optoelectronic oscilloscope probe for measuring floating electrical signals of a test device, wherein the electrical signal in the sensor head of the probe is turned into an analog light signal. This light signal is transmitted to a receiver unit over a fiber optic cable, which converts it back into an equivalent electrical signal, and transfers it to an oscilloscope. The energy supply of the sensor head is provided entirely autonomously by means of a built-in battery/accumulator. The components of the sensor head are housed in a generally sealed metallic package.

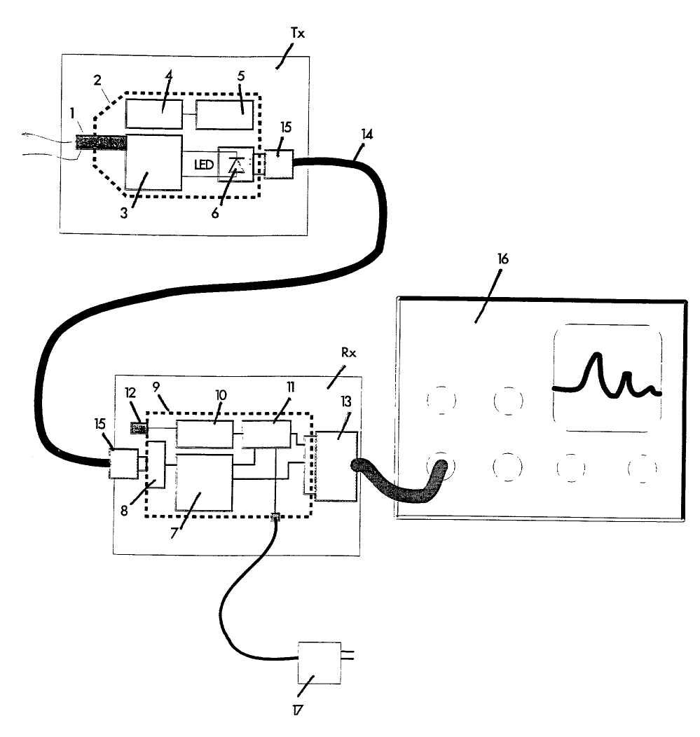

### BACKGROUND OF THE INVENTION

1. Field of the Invention

This invention relates to optoelectronic oscilloscope probe for measuring floating electrical signals.

2. The Prior Art

Conventionally built oscilloscope probes generally include a sample tip which has to be adapted to the device under test, and have an electrical wire connected to the oscilloscope. There is also an electrical component for adjusting the voltages which have to be measured within the measurement range of the oscilloscope.

To measure voltages having a reference potential which is different from that of the oscilloscope, active differential probes are used. The maximum potential difference to be bridged, between the reference potential of the oscilloscope and the reference potential of the device under that is determined by the maximum common-mode input voltage range of the measurement amplifier used. Measurements of a device with a very high voltage potential cannot be performed this way. Interferences via the electrical wire to the oscilloscope, due to switching transistors in the power supplies, and in the drive technique come from the rapidly changing potential difference. Measuring electrical signals in an environment which has high electromagnetic fields leads to interferences in the measurement cable setup. Grounded loops, built via the test wire as a result of grounding the device under test with the oscilloscope, also result in distorted test results, or make manual tests impossible. Problems also occur when, for example, a device under test is specifically loaded with unitized glitches, such as a Burst test, within the context of an interference immunity test. As a result of the physical proximity or of the electrical wire to the oscilloscope, there are often unwanted interferences in the test setup. Therefore, useful and accurate measurements can be impossible. Measurements on the device under test within the context of an interference radiation immunity test (HF-radiation) also cannot be performed with conventional probes, as there are interferences in the measurement cable setup.

### SUMMARY OF THE INVENTION

The present invention provides a means of accurately measuring analog or digital electrical signals of a test device, independent of the electrical interference previously described.

The invention provides an optoelectronic oscilloscope probe for measuring floating electrical signals wherein the electrical signal in the sensor head is turned into an analog light signal, and is sent out over a fiber optic cable. The light signal is then converted back to an electrical signal in the receiver unit, and then transferred to an oscilloscope. The power supply of the sensor head is entirely autonomous by means of a built-in battery/accumulator. There is an analog transfer of the signal in the entire setup. All the units of the sensor head are contained in a metallic package which is generally shielded.

This invention enables the interference-free free measurement of electrical signals in connection with an oscilloscope, in areas with significant and strong electromagnetic interference. By sending that signal over a fiber optic cable, and by providing a self contained energy supply such as a battery in the sensor head, electrical signals can be measured without any problems for different reference potentials. These reference potentials can also change with very high voltage peaks without leading to any signal distortion. The signals can be transmitted without any problems due to long distances, and without leading to interference. The probe of the invention also provides a safe, accurate and interference-free measurement from high-voltage systems. The formation of ground loops in the test setup is prevented by the grounded design of the sensor head, and the signal transfer over the fiber optic cable. The closed metallic shield of the sensor head and the signal transfer over the fiber optic cable also enable tests to be performed under the influence of extremely strong electromagnetic fields. Analog and digital signals can be measured universally in the oscilloscope measurement technology. Due to the chosen analog transfer process, there is a high transfer bandwidth, and short pulses can be measured and transmitted.

### BRIEF DESCRIPTION OF THE DRAWING

Other objects and features of the present invention will become apparent from the following detailed description considered in connection with the accompanying drawing. It should be understood, however, that the drawing is designed for the purpose of illustration only, and not as a definition of the limits of the invention.

The figure is an electrical block diagram showing one embodiment of the invention.

### DETAILED DESCRIPTION OF THE PREFERRED EMBODIMENT

Referring to the figure, the signal which is to be measured is fed to input contact 1 of sensor head TX, and subsequently amplified or attenuated in the amplifier/ impedance converter 3, so that it is suitable for the control of an electro optical converter such as a LED/laser diode. The voltage supply of amplifier 3 is provided by a battery/ accumulator 5 which is placed in sensor head TX, wherein required supply voltages are adjusted by voltage supply unit 4. All the components of sensor head TX are housed in a sealed and shielded metallic package 2.

A fiber optic cable 14 is connected to the output of electro optical transducer 6 of sensor head TX, and to an optoelectronic transducer 8, of a receiver unit RX by means of connectors 15, thus establishing the communication line for the transfer of the signal. The light signal which is transmitted to the optoelectronic transducer 8 over fiber optic cable 14 is converted back to an electrical signal, and transmitted to an oscilloscope 16 over a connector 13 after adjustment in an amplifier 7. A separate AC power adapter 17 or the oscilloscope provide the supply voltages which are used in receiver unit RX. A power supply unit 11 adjusts and regulates the power from AC power adapter 17. There is provided a calibration generator 10, having a signal which can be sampled at external connector 12 to allow for calibration of the entire test setup. The components of receiver unit RX are also housed in a sealed and shielded metallic package 9.

Accordingly, while only a single embodiment of the present invention has been shown and described, it is to be understood that many changes and modifications may be made thereunto without departing from the spirit and scope of the invention as defined in the appended claims.

What is claimed is:

1. A optoelectronic oscilloscope probe for measuring the electrical signals of a device under test comprising:
a sensor head for converting the electrical signals into an analog light signal;
fiber optic cable coupled its said sensor head for receiving the analogue light signal; and
a receiver unit coupled to said cable for converting the analogue light signal to an equivalent electrical signal and transferring the electrical signal to an oscilloscope.

2. The probe as recited in claim 1, comprising an autonomous energy supply coupled to said sensor head.

3. The probe is recited in claim 2, wherein said energy supply comprises a built-in battery/accumulator.

4. The probe as recited in claim 1, wherein there is an analog transfer and transmission of the signal in the entire circuit.

5. The probe as recited in claim 1, wherein said sensor head is housed in a sealed metallic package for shielding.

6. The probe according to claim 1, wherein said receiver further comprise an optoelectronic transducer coupled to said optical cable for converting the analog light signal to an equivalent electrical signal.

7. The probe according to claim 1, wherein said receiver additionally comprises a calibration generator for calibrating the probe and receiver.
